(19) United States
(12) Patent Application Publication
(10) Pub. No.: US 2021/0247655 A1
(43) Pub. Date: Aug. 12, 2021

(54) DISPLAY SUBSTRATE, DISPLAY MODULE, METHOD FOR DRIVING DISPLAY MODULE, AND DISPLAY APPARATUS

(71) Applicants: HEFEI BOE OPTOELECTRONICS TECHNOLOGY CO., LTD., Hefei, Anhui (CN); BOE TECHNOLOGY GROUP CO., LTD., Beijing (CN)

(72) Inventors: Guojun ZHANG, Beijing (CN); Li JIANG, Beijing (CN); Jiong HUANG, Beijing (CN); Peng LI, Beijing (CN); Lele HAN, Beijing (CN); Juncai MA, Beijing (CN)

(73) Assignees: HEFEI BOE OPTOELECTRONICS TECHNOLOGY CO., LTD., Hefei, Anhui (CN); BOE TECHNOLOGY GROUP CO., LTD., Beijing (CN)

(21) Appl. No.: 17/042,714

(22) PCT Filed: Mar. 10, 2020
(86) PCT No.: PCT/CN2020/078625

§ 371 Date: Sep. 28, 2020

(30) Foreign Application Priority Data
Mar. 27, 2019 (CN) 201910237968.9

(51) Int. Cl. G02F 1/157; G02F 1/01; G06K 9/00; G09G 3/38; G09G 3/20

(52) U.S. Cl. CPC G02F 1/157; G02F 1/0126; G02F 1/1524; G09G 3/38; G09G 3/2003; G06K 9/0004

(57) ABSTRACT

A display substrate, a display module and a method for driving the display module, and a display apparatus are provided. The display substrate includes a plurality of pixel units. At least one pixel unit includes: a first sub-pixel; a color-changing layer covering a part of a light-emitting surface of the first sub-pixel, the color-changing layer being able to be switched between a first state and a second state, and the color-changing layer being configured to enable a first wavelength light emitted by the first sub-pixel to pass through the color-changing layer in the first state; and a light-emitting layer located on a side of the color-changing layer that is away from the first sub-pixel, and configured to emit a second wavelength light under excitation of the first wavelength light. The second wavelength light is an invisible light.

### CROSS-REFERENCE TO RELATED APPLICATION

This application claims priority to Chinese Patent Application No. 201910237968.9, filed in China on Mar. 27, 2019, the entire content of which is incorporated herein by reference.

### TECHNICAL FIELD

The present disclosure relates to the field of display technologies, and in particular to a display substrate, a display module, a method for driving the display module, and a display apparatus.

### BACKGROUND

Fingerprints are a pattern of lines formed by protrusions (namely, fingerprint peaks) and depressions (namely, fingerprint valleys) on epidermis layers of fingers. Due to features such as lifelong invariance, uniqueness, and convenience, fingerprints have become one of mainstreams of biometric feature identification, and are widely used in identity information authentication and identification fields such as security protection facilities and attendance systems.

Currently, a full screen is a main development trend of a display apparatus. Fingerprint identification by using an optical fingerprint identification module on the screen is a main manner in which the full-screen display apparatus is used to identify fingerprints of a user.

### SUMMARY

According to a first aspect, an embodiment of the present disclosure provides a display substrate, including a plurality of pixel units. At least one of the plurality of pixel units includes: a first sub-pixel; a color-changing layer covering a part of a light-emitting surface of the first sub-pixel, where the color-changing layer is switchable between a first state and a second state, and the color-changing layer is configured to enable a first wavelength light emitted by the first sub-pixel to pass through the color-changing layer in the first state; and a light-emitting layer, located on a side of the color-changing layer that is away from the first sub-pixel, and configured to emit a second wavelength light under excitation of the first wavelength light, where the second wavelength light is an invisible light.

In some optional embodiments, the color-changing layer is configured to cause the first wavelength light to be incapable of passing through the color-changing layer in the second state.

In some optional embodiments, the color-changing layer is an electrochromic layer. The electrochromic layer is configured to be in the first state during power-off and be in the second state during power-on; or the electrochromic layer is configured to be in the first state during the power-on and be in the second state during the power-off.

In some optional embodiments, the color-changing layer is a photochromic layer. The photochromic layer is configured to be in the first state when the first wavelength light enters the photochromic layer and be in the second state when no first wavelength light enters the photochromic layer; or the photochromic layer is configured to be in the first state when no first wavelength light enters the photochromic layer and be in the second state when the first wavelength light enters the photochromic layer.

In some optional embodiments, the color-changing layer includes cobalt oxide.

In some optional embodiments, the second wavelength light is within an infrared light wave band, the first sub-pixel is a blue sub-pixel, and the light-emitting layer is made of a material that emits an infrared light under excitation of a blue light.

In some optional embodiments, the material that emits the infrared light under excitation of the blue light includes K2SiF6:Mn4+ and K2SnF6:Mn4+.

In some optional embodiments, a groove is arranged on the first sub-pixel, the color-changing layer and the light-emitting layer are located in the groove of the first sub-pixel, and the groove is located in a central region or an edge region of the first sub-pixel.

According to a second aspect, an embodiment of the present disclosure further provides a display module, including a display substrate described above; a light source arranged on a light-incident side of the display substrate; and an optical sensor arranged on a light-exiting side of the display substrate, and configured to collect the second wavelength light emitted by the light-emitting layer of at least one of the plurality of pixel units and reflected by a finger, and identify fingerprint information based on the collected second wavelength light.

In some optional embodiments, the first sub-pixel includes a first portion covered by the color-changing layer and the light-emitting layer, and a second portion not covered by the color-changing layer and the light-emitting layer. The first portion of the first sub-pixel is configured to identify the fingerprint information in the first state, and the second portion of the first sub-pixel is configured to display an image under illumination of the light source.

In some optional embodiments, each of the plurality of pixel units further includes a second sub-pixel and a third sub-pixel that are configured to display an image, and the first sub-pixel, the second sub-pixel, and the third sub-pixel are configured to emit lights with different colors.

According to a third aspect, an embodiment of the present disclosure further provides a method for driving the display module described above, including: when a fingerprint identification instruction is received, controlling the color-changing layer in at least one of the plurality of pixel units to be in the first state, to enable the first wavelength light to pass through the color-changing layer; and turning on the light source, collecting, by using the optical sensor, the second wavelength light emitted by the light-emitting layer in the at least one pixel unit and reflected by the finger, and identifying the fingerprint information based on the collected second wavelength light.

In some optional embodiments, the first sub-pixel includes a first portion covered by the color-changing layer and the light-emitting layer, and a second portion not covered by the color-changing layer and the light-emitting layer. The method includes: when the fingerprint identification instruction is received, controlling the first portion of the first sub-pixel in the at least one pixel unit and the optical sensor to identify the fingerprint information, and controlling the second portion of the first sub-pixel in the at least one pixel unit to display an image.

In some optional embodiments, the color-changing layer is configured to cause the first wavelength light to be incapable of passing through the color-changing layer in the second state, and the display module includes a first pixel unit and a second pixel unit that are adjacent to each other. The controlling the color-changing layer in the at least one pixel unit to be in the first state to enable the first wavelength light to pass through the color-changing layer includes: controlling a color-changing layer in the first pixel unit to be in the first state and controlling a color-changing layer in the second pixel unit to be in the second state, so that the first wavelength light transmits through the color-changing layer in the first pixel unit and enters the light-emitting layer.

In some optional embodiments, the controlling the color-changing layer in the first pixel unit to be in the first state and controlling the color-changing layer in the second pixel unit to be in the second state includes: controlling a color-changing layer in a pixel unit in an odd-numbered row in an odd-numbered column to be in the first state, and controlling color-changing layers in other pixel units to be in the second state; or controlling a color-changing layer in a pixel unit in an odd-numbered row in an even-numbered column to be in the first state, and controlling color-changing layers in other pixel units to be in the second state; or controlling a color-changing layer in a pixel unit in an even-numbered row in an odd-numbered column to be in the first state, and controlling color-changing layers in other pixel units to be in the second state; or controlling a color-changing layer in a pixel unit in an even-numbered row in an even-numbered column to be in the first state, and controlling color-changing layers in other pixel units to be in the second state.

In some optional embodiments, the controlling the color-changing layer in the first pixel unit to be in the first state and controlling the color-changing layer in the second pixel unit to be in the second state includes: in a first time period, controlling the color-changing layer in the pixel unit in the odd-numbered row in the odd-numbered column to be in the first state, and controlling the color-changing layers in other pixel units to be in the second state; and in a second time period, controlling the color-changing layer in the pixel unit in the odd-numbered row in the odd-numbered column to be in the second state, and controlling the color-changing layers in other pixel units to be in the first state; or in a first time period, controlling the color-changing layer in the pixel unit in the odd-numbered row in the even-numbered column to be in the first state, and controlling the color-changing layers in other pixel units to be in the second state; and in a second time period, controlling a color-changing layer in a pixel unit in the odd-numbered row in the even-numbered column to be in the second state, and controlling the color-changing layers in other pixel units to be in the first state; or in a first time period, controlling a color-changing layer in a pixel unit in an even-numbered row and odd-numbered column to be in the first state, and controlling a color-changing layer in another pixel unit to be in the second state; and in a second time period, controlling a color-changing layer in a pixel unit in an even-numbered row and odd-numbered column to be in the second state, and controlling a color-changing layer in another pixel unit to be in the first state; or in a first time period, controlling the color-changing layer in the pixel unit in the even-numbered row in the even-numbered column to be in the first state, and controlling the color-changing layers in other pixel units to be in the second state; and in a second time period, controlling the color-changing layer in the pixel unit in the even-numbered row in the even-numbered column to be in the second state, and controlling the color-changing layers in other pixel units to be in the first state.

According to a fourth aspect, an embodiment of the present disclosure further provides a display apparatus, including the display module described above.

### BRIEF DESCRIPTION OF DRAWINGS

To describe the technical solutions in embodiments of the present disclosure more clearly, the accompanying drawings required for describing the embodiments of the present disclosure are briefly described in the following. Apparently, the accompanying drawings in the following description are merely part of embodiments of the present disclosure, and the person skilled in the art can still obtain other drawings according to these accompanying drawings without creative effort.

FIG. 1 is a top view of a pixel unit in a display substrate according to some embodiments of the present disclosure;

FIG. 2 is a sectional view along Line A-A in FIG. 1;

FIG. 3a is a schematic view in which a light-emitting layer in a display substrate emits light provided by some embodiments of the present disclosure;

FIG. 3b is a schematic view in which a light-emitting layer in a display substrate emits no light provided by some embodiments of the present disclosure;

FIG. 4 is a schematic structural view of a display module provided by some embodiments of the present disclosure;

FIG. 5 is a flowchart of a method for driving a display module provided by some embodiments of the present disclosure;

FIG. 6a is a state distribution view I of a color-changing layer in a pixel unit in a method for driving a display module provided by some embodiments of the present disclosure;

FIG. 6b is a state distribution view II of a color-changing layer in a pixel unit in a method for driving a display module provided by some embodiments of the present disclosure;

FIG. 6c is a state distribution view III of a color-changing layer in a pixel unit in a method for driving a display module provided by some embodiments of the present disclosure; and

FIG. 6d is a state distribution view IV of a color-changing layer in a pixel unit in a method for driving a display module provided by some embodiments of the present disclosure.

### DETAILED DESCRIPTION

The technical solutions in embodiments of the present disclosure will be described clearly and completely with reference to the drawings in the embodiments of the present disclosure. It is obvious that the described embodiments are only a part of embodiments of the present disclosure, rather than all embodiments. All other embodiments, which can be obtained by a person skilled in the art based on the embodiments of the present disclosure without creative effort, shall fall within the protection scope of the present disclosure.

In the related technology, an infrared light source needs to be additionally arranged at a specific location of a cover plate of a display apparatus, so as to realize a function of identifying a user's fingerprint at a specific location. The infrared light source is additionally arranged, and consequently, not only the production cost of the display apparatus is increased, but also the thickness of the display apparatus is increased.

To resolve the above problems, an embodiment of the present disclosure provides a display substrate, a display module and a method for driving the display module, and a display apparatus, to be able to reduce the manufacturing cost of the display apparatus, realize the full-screen fingerprint identification of the display apparatus, and realize the fingerprint identification while displaying.

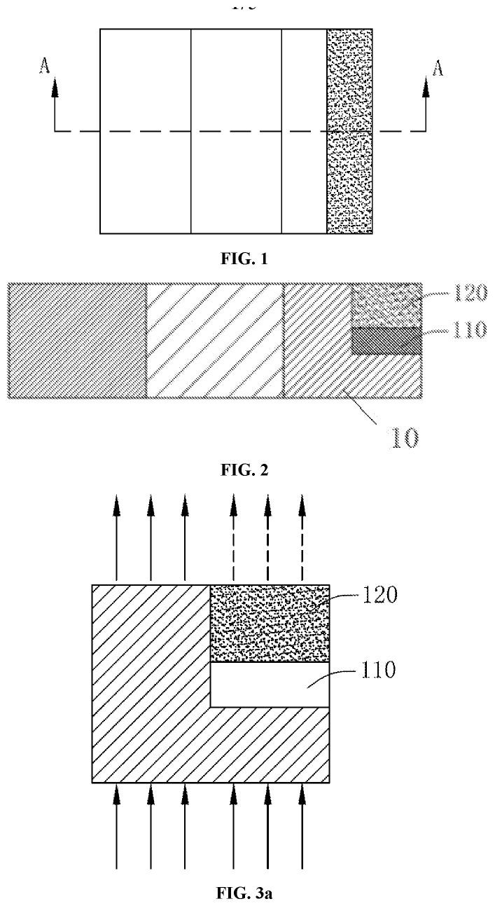

Embodiments of the present disclosure provide a display substrate, including a plurality of pixel units, as shown in FIG. 1 and FIG. 2. At least one of the pixel units is provided thereon with: a first sub-pixel 10; a color-changing layer 110 covering a part of a light-emitting surface of the first sub-pixel, where the color-changing layer 110 can be switched between a first state and a second state, and the color-changing layer 110 is configured to enable a first wavelength light emitted by the first sub-pixel to pass through the color-changing layer in the first state; and a light-emitting layer 120, located on a side of the color-changing layer 110 that is away from the first sub-pixel 10, and configured to emit a second wavelength light under the excitation of the first wavelength light, where the second wavelength light is an invisible light.

In the embodiments of the present disclosure, the color-changing layer 110 and the light-emitting layer 120 are additionally arranged on a part of the light-emitting surface of the first sub-pixel. When a fingerprint needs to be identified, the first wavelength light emitted by the first sub-pixel is controlled to pass through the color-changing layer 110, and the light-emitting layer 120 emits the second wavelength light under the excitation of the first wavelength light. The second wavelength light emitted by the light-emitting layer 120 is used as a light source for fingerprint identification, and a first wavelength light emitted by another part of the light-emitting surface of the first sub-pixel and that is not covered by the color-changing layer 110 and the light-emitting layer 120 is used for normal image display. Therefore, fingerprint information is identified with the second wavelength light without affecting a display effect. The second wavelength light is usually the infrared light. In this way, an infrared light source does not need to be additionally added in the display apparatus, thereby reducing the manufacturing cost of the display apparatus, and being able to realize full-screen fingerprint identification. Therefore, the technical solution provided in the present disclosure can reduce the manufacturing cost of the display apparatus, and realize the full-screen fingerprint identification of the display apparatus.

A pixel unit may include a first sub-pixel, a second sub-pixel, and a third sub-pixel. As shown in FIG. 1, a rightmost sub-pixel is the first sub-pixel. FIG. 2 is a sectional view obtained through cutting along Line A-A in FIG. 1. A part of the light-emitting surface of the first sub-pixel is covered by the color-changing layer 110 and the light-emitting layer 120, and the remaining part of the first sub-pixel still cooperates with the sub-pixels with other colors in the pixel unit, so as to ensure that the display apparatus can normally display a picture. The pixel unit can further include other quantities of the sub-pixels, and the above description is merely an example. It should be considered that a case in which the pixel unit includes any quantity of the sub-pixels falls within the protection scope of the present disclosure.

In some embodiments, the color-changing layer 110 and the light-emitting layer 120 may be attached onto the light-emitting surface of the first sub-pixel. In other optional embodiments, the first sub-pixel is designed as a structure with a groove, and the color-changing layer 110 and the light-emitting layer 120 are arranged in the groove (as shown in FIG. 2). In this way, the thickness of the pixel unit is not additionally increased, thereby lightening and thinning the display substrate. The groove may be located in a central region of the first sub-pixel, or may be located in an edge region of the first sub-pixel.

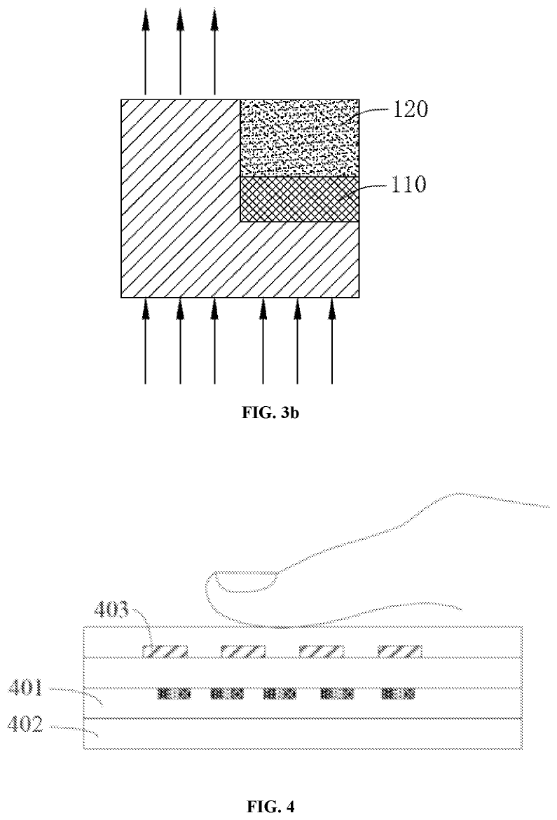

In some embodiments, the color-changing layer 110 in the first state serves as a transparent layer, to enable the first wavelength light to transmit to the light-emitting layer, so that the light-emitting layer emits the second wavelength light under the excitation of the first wavelength light for the fingerprint identification, as shown in FIG. 3a.

In other optional embodiments, the color-changing layer 110 in the second state serves as a colored layer. The color of the colored layer is different from a first color, and the first wavelength light cannot penetrate the colored layer. Consequently, the light-emitting layer cannot emit the second wavelength light, as shown in FIG. 3b.

The light-emitting layer 120 is configured to cooperate with an optical sensor, so that the optical sensor identifies the fingerprint information of a user under the illumination of an invisible light without affecting the display effect of the display apparatus. The light-emitting layer can emit an infrared light, an ultraviolet light or other invisible lights, which are not limited by embodiments of the present disclosure.

In some optional embodiments, the light-emitting layer 120 may be made of a material that emits an infrared light under excitation of a blue light. In this case, the first wavelength light is the blue light, and the second wavelength light is the infrared light. In some optional embodiments, the light-emitting layer 120 may be made of a material in which a green light excites the ultraviolet light. In this case, the first wavelength light is the green light, and the second wavelength light is the ultraviolet light. In an embodiment of the present disclosure, the light-emitting layer can be made of another material that emits the invisible light under excitation of a monochromatic visible light of another color, and the above description is merely an example. It should be considered that a material that emits the invisible light under excitation of a monochromatic visible light of any color shall fall within the protection scope of the present disclosure.

In some optional embodiments, the color-changing layer is configured to cause the first wavelength light to be incapable of passing through the color-changing layer in the second state.

In the embodiments, when the fingerprint information of the user needs to be detected, the display apparatus switches the color-changing layer 110 to the first state, so that the light-emitting layer 120 emits the invisible light under the excitation of the first wavelength light, which is used as the light source for the fingerprint identification. When the fingerprint information of the user does not need to be detected, the display apparatus switches the color-changing layer 110 to the second state.

In some optional embodiments, the color-changing layer 110 is an electrochromic layer.

The color-changing layer 110 is in the first state when the electrochromic layer is powered off, and the color-changing layer 110 is in the second state when the electrochromic layer is powered on; or the color-changing layer 110 is in the first state when the electrochromic layer is powered on, and the color-changing layer 110 is in the second state when the electrochromic layer is powered off.

The color-changing layer 110 is in the first state when the electrochromic layer is powered off, and the color-changing layer 110 is in the second state when the electrochromic layer is powered on. When the display apparatus needs to detect the fingerprint information, the display apparatus can stop supplying electric energy to the electrochromic layer, so that the light-emitting layer 120 emits the invisible light, which serves as the light source for the fingerprint identification. When the display apparatus does not need to detect the fingerprint information, the display apparatus supplies electric energy to the electrochromic layer, to avoid interference between the invisible light and other visible lights.

Because a proportion of the time of identifying the fingerprint information to the total time of display is relatively small, more electric energy can be saved and standby duration of the display apparatus can be prolonged in a manner in which the color-changing layer 110 is in the first state when the electrochromic layer is powered on and the color-changing layer 110 is in the second state when the electrochromic layer is powered off.

In some optional embodiments, the color-changing layer 110 may be made of a material including cobalt oxide and the like.

In some optional embodiments, electrochromic layers in the plurality of pixel units are connected to separate switches to independently control the power-on of the respective electrochromic layers thereof, so as to avoid light crosstalk between adjacent pixels. In some optional embodiments, the above invisible light is the infrared light. The first sub-pixel is a blue sub-pixel. The light-emitting layer 120 is made of the material that emits the infrared light under excitation of the blue light.

In the embodiments, the material that emits the infrared light under excitation of the blue light may be a red nanophosphor formed by K₂SiF₆:Mn⁴⁺ and K₂SnF₆:Mn⁴⁺. When the color-changing layer is switched to the first state, the light-emitting layer emits the infrared light under the excitation of the blue light.

In some optional embodiments, the color-changing layer is a photochromic layer. The photochromic layer is configured to be in the first state when the first wavelength light enters the photochromic layer and be in the second state when no first wavelength light enters the photochromic layer; or the photochromic layer is configured to be in the first state when no first wavelength light enters the photochromic layer and be in the second state when the first wavelength light enters the photochromic layer.

Embodiments of the present disclosure further provide a display module as shown in FIG. 4, which includes a display substrate 401 described above. The display module further includes a light source 402 arranged on a light-incident side of the display substrate 401; and an optical sensor 403 arranged on a light-exiting side of the display substrate 401, and configured to collect the second wavelength light emitted by the light-emitting layer of at least one pixel unit and reflected by a finger, and identify fingerprint information based on the collected second wavelength light.

The light source 403 may be a white light source, or may be a backlight source in a backlight module, which is not limited herein. When the light source 403 illuminates the display substrate 401 and the color-changing layer is a colored layer, the colored layer emits a light of a color corresponding to the colored layer from a light-emitting side under the illumination of light. As a result, the light-emitting layer cannot receive the first wavelength light, thereby being incapable of emitting an invisible light.

It can be understood that the number of optical sensors can be the same as or different from the number of pixel units having the colored layer and the light-emitting layer. As shown in FIG. 4, the number of the optical sensors is the same as the number of the pixel units having the colored layer and the light-emitting layer, and the optical sensors are in a one-to-one correspondence with the pixel units. The present disclosure is not limited thereto.

As shown in FIG. 4, the optical sensor 403 is located between a finger of a user and the display substrate 401. After an invisible light-emitting layer emits the invisible light, the optical sensor 403 can identify the fingerprint information obtained when the invisible light is reflected by valleys and ridges of a fingerprint of a user.

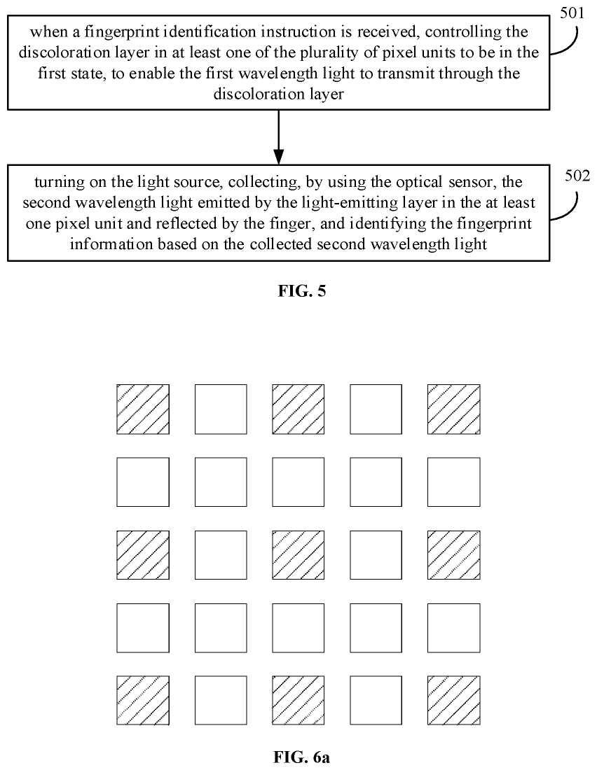

Embodiments of the present disclosure further provide a method for driving the display module described above and as shown in FIG. 5. The method includes:

step 501: when a fingerprint identification instruction is received, controlling the color-changing layer in at least one of the plurality of pixel units to be in the first state, to enable the first wavelength light to pass through the color-changing layer; and

step 502: turning on the light source, collecting, by using the optical sensor, the second wavelength light emitted by the light-emitting layer in the at least one pixel unit and reflected by the finger, and identifying the fingerprint information based on the collected second wavelength light.

In the embodiments of the present disclosure, a color-changing layer and a light-emitting layer are additionally arranged on a part of a light-emitting surface of a first sub-pixel. When a fingerprint needs to be identified, the first wavelength light penetrates the color-changing layer, so as to facilitate the light-emitting layer to emit an invisible light. The fingerprint information is identified by using the invisible light without affecting a display effect. In this way, an infrared light source does not need to be additionally added in the display apparatus, thereby reducing the manufacturing cost of the display apparatus, and realizing full-screen fingerprint identification. Therefore, the technical solution provided in the present disclosure can reduce the manufacturing cost of the display apparatus, and realize the full-screen fingerprint identification of the display apparatus.

A pixel unit may include three sub-pixels. As shown in FIG. 1, a rightmost sub-pixel is the first sub-pixel. FIG. 2 is a sectional view obtained through cutting along Line A-A in FIG. 1. A part of a light-emitting surface of the first sub-pixel is covered by the color-changing layer and an invisible light-emitting layer, and the remaining part of the first sub-pixel still cooperates with sub-pixels of other colors in the pixel unit, so as to ensure that the display apparatus can normally display a picture. The pixel unit may further include other quantities of the sub-pixels, and the above description is merely an example. It should be considered that a case in which the pixel unit includes any number of the sub-pixels shall fall within the protection scope of the present disclosure.

The color-changing layer and the invisible light-emitting layer may be attached onto the light-emitting surface of the first sub-pixel. Alternatively, the first sub-pixel may be designed as a structure with a groove, and the color-changing layer and the light-emitting layer are then arranged in the groove (as shown in FIG. 2). In this way, the thickness thereof is not additionally increased, thereby lightening and thinning the display substrate. The groove maybe located in a central region of the first sub-pixel, or may be located in an edge region of the first sub-pixel.

In some embodiments, the color-changing layer serves as a transparent layer in the first state, so as to enable the first wavelength light to transmit to the light-emitting layer, so that the light-emitting layer emits the second wavelength light under the excitation of the first wavelength light for fingerprint identification, as shown in FIG. 3a.

In a plurality of other optional embodiments, the color-changing layer serves as a colored layer in the second state. The color of the colored layer is different from a first color, and the first wavelength light cannot penetrate the colored layer. Consequently, the light-emitting layer cannot emit the second wavelength light, as shown in FIG. 3b.

The light-emitting layer is configured to cooperate with an optical sensor, so that the optical sensor identifies the fingerprint information of a user under the illumination of the invisible light without affecting a display effect of the display apparatus. The light-emitting layer may emit an infrared light, an ultraviolet light or other invisible lights, which are not limited by an embodiment of the present disclosure.

In some optional embodiments, the light-emitting layer may be made of a material that emits an infrared light under excitation of a blue light. In this case, the first wavelength light is the blue light, and the invisible light is the infrared light. In some optional embodiments, the light-emitting layer may be made of a material that emits the ultraviolet light under excitation of a green light. In this case, the first wavelength light is the green light, and the invisible light is the ultraviolet light. In an embodiment of the present disclosure, the light-emitting layer may be made of another material that emit the invisible light under excitation of a monochromatic visible light of another color, and the above description is merely an example. It should be considered that a material that emits the invisible light under excitation of a monochromatic visible light of any color shall fall within the protection scope of the present disclosure.

In some optional embodiments, the color-changing layer is configured to cause the first wavelength light to be incapable of passing through the color-changing layer in the second state. The display module includes a first pixel unit and a second pixel unit that are adjacent to each other. The controlling the color-changing layer in the at least one pixel unit to be in the first state to enable the first wavelength light to pass through the color-changing layer includes: controlling a color-changing layer in the first pixel unit to be in the first state, and controlling a color-changing layer in the second pixel unit to be in a second state, so that the first wavelength light transmits through the color-changing layer in the first pixel unit, and enters the light-emitting layer.

In these embodiments, two adjacent invisible light generation layers do not simultaneously emit the invisible lights, so as to avoid the interference between the invisible lights emitted by the two adjacent invisible light generation layers, thereby improving the precision of identifying the fingerprint information by the optical sensor.

In some optional embodiments, the controlling the color-changing layer in the first pixel unit to be in the first state and controlling the color-changing layer in the second pixel unit to be in the second state includes: controlling a color-changing layer in a pixel unit in an odd-numbered row in an odd-numbered column to be in the first state, and controlling color-changing layers in other pixel units to be in the second state; or controlling a color-changing layer in a pixel unit in an odd-numbered row in an even-numbered column to switch to the first state, and controlling color-changing layers in other pixel units to be in the second state; or controlling a color-changing layer in a pixel unit in an even-numbered row in an odd-numbered column to switch to the first state, and controlling color-changing layers in other pixel units to be in the second state; or controlling a color-changing layer in a pixel unit in an even-numbered row in an even-numbered column to switch to the first state, and controlling color-changing layers in other pixel units to be in the second state.

In some optional embodiments, the controlling the color-changing layers in the first pixel unit to be in the first state and controlling the color-changing layer in the second pixel unit to be in the second state includes: in a first time period, controlling the color-changing layer in the pixel unit in the odd-numbered row in the odd-numbered column to be in the first state, and controlling the color-changing layers in other pixel units to be in the second state; and in a second time period, controlling the color-changing layer in the pixel unit in the odd-numbered row in the odd-numbered column to be in the second state, and controlling the color-changing layers in other pixel units to be in the first state; or in a first time period, controlling the color-changing layer in the pixel unit in the odd-numbered row in the even-numbered column to switch to the first state, and controlling the color-changing layers in other pixel units to be in the second state; and in a second time period, controlling the color-changing layer in the pixel unit in the odd-numbered row in the even-numbered column to switch to the second state, and controlling the color-changing layers in other pixel units to be in the first state; or in a first time period, controlling the color-changing layer in the pixel unit in the even-numbered row in the odd-numbered column to switch to the first state, and controlling the color-changing layers in other pixel units to be in the second state; and in a second time period, controlling the color-changing layer in the pixel unit in the even-numbered row in the odd-numbered column to switch to the second state, and controlling the color-changing layers in other pixel units to be in the first state; or in a first time period, controlling the color-changing layer in the pixel unit in the even-numbered row in the even-numbered column to switch to the first state, and controlling the color-changing layers in other pixel units to be in the second state; and in a second time period, controlling the color-changing layer in the pixel unit in the even-numbered row in the even-numbered column to switch to the second state, and controlling the color-changing layers in other pixel units to be in the first state.

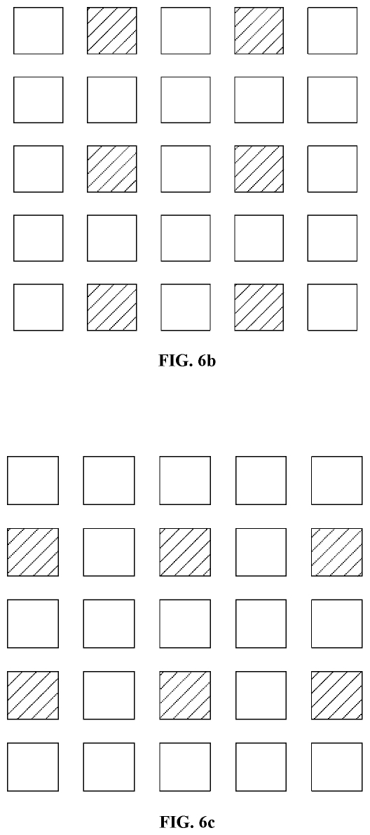

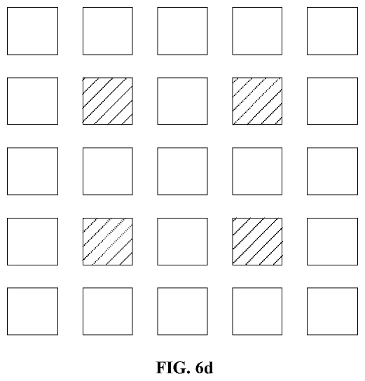

Any one of the above four cases may be selected to control the color-changing layer, or the four cases may be controlled in turn in a specific order. For example, in a first frame, the color-changing layers in the pixel unit in the odd-numbered row in the odd-numbered column are switched to the first state, and the color-changing layers in other pixel units are switched to the second state. As shown in FIG. 6a, a color-changing layer in a pixel unit filled with a pattern is in the first state, and a color-changing layer in a blank pixel unit is in the second state. In a second frame, the color-changing layers in the pixel unit in the odd-numbered row in the even-numbered column are switched to the first state, and the color-changing layers in other pixel units are switched to the second state, as shown in FIG. 6b. In a third frame, the color-changing layers in the pixel unit in the even-numbered row in the odd-numbered column are switched to the first state, and the color-changing layers in other pixel units are switched to the second state, as shown in FIG. 6c. In a fourth frame, the color-changing layers in the pixel unit in the even-numbered row in the even-numbered column are switched to the first state, and the color-changing layers in other pixel units are switched to the second state, as shown in FIG. 6d. The four cases are not limited to the previous order when being controlled in turn. In an embodiment of the present disclosure, adjacent pixel units are controlled to emit light in different time sequences, so as to avoid the interference between the adjacent pixels and the crosstalk between reflected light of the light source.

Embodiments of the present disclosure further provide a display apparatus, including the display module described above.

The display apparatus can be any product or component that has a display function, such as a television, a display, a digital photo frame, a mobile phone, a tablet computer, a navigator or the like. The display apparatus further includes a flexible circuit board, a printed circuit board, and a backplane.

Unless otherwise defined, the technical or scientific terms used in the present disclosure shall be in the general meaning understood by the person skilled in the art to which the present disclosure belongs. The words “first”, “second”, and similar words used in the present disclosure do not indicate any order, number, or importance, but are merely intended to distinguish between different components. The word such as “comprise”, “include” or the like means that elements or objects preceding the word cover elements or objects listed following the word and equivalents thereof, rather than exclude other elements or objects. The words such as “connection”, “connected” or the like are not limited to a physical connection or a mechanical connection, but can comprise an electrical connection, regardless of both direct and indirect connections. Terms such as “on”, “under”, “left”, “right”, or the like are merely used to indicate a relative position relationship. When an absolute position of a described object changes, the relative position relationship can change accordingly.

It can be understood that when an element such as a layer, a film, a region, or a substrate is “on” or “under” another element, the element can be “directly” “on” or “under” another element, or an intermediate element can be provided.

The embodiments of the present disclosure are described above with reference to the accompanying drawings. However, the present disclosure is not limited to the above specific embodiments. The above specific embodiments are merely illustrated, but are not limited. Based on the motivation of the present disclosure, a person skilled in the art can make many forms without departing from the spirit and the protection scope of the claims of the present disclosure, which shall all fall within the protection scope of the present disclosure.

1. A display substrate, comprising a plurality of pixel units, wherein at least one of the plurality of pixel units comprises:
a first sub-pixel;
a color-changing layer covering a part of a light-emitting surface of the first sub-pixel, wherein the color-changing layer is switchable between a first state and a second state, and the color-changing layer is configured to enable a first wavelength light emitted by the first sub-pixel to pass through the color-changing layer in the first state; and
a light-emitting layer, located on a side of the color-changing layer that is away from the first sub-pixel, and configured to emit a second wavelength light under excitation of the first wavelength light, wherein the second wavelength light is an invisible light.

2. The display substrate according to claim 1, wherein the color-changing layer is configured to cause the first wavelength light to be incapable of passing through the color-changing layer in the second state.

3. The display substrate according to claim 2, wherein the color-changing layer is an electrochromic layer;
the electrochromic layer is configured to be in the first state during power-off, and be in the second state during power-on; or
the electrochromic layer is configured to be in the first state during power-on, and be in the second state during power-off.

4. The display substrate according to claim 2, wherein the color-changing layer is a photochromic layer;
the photochromic layer is configured to be in the first state when the first wavelength light enters the photochromic layer, and be in the second state when no first wavelength light enters the photochromic layer; or
the photochromic layer is configured to be in the first state when no first wavelength light enters the photochromic layer, and be in the second slate when the first wavelength light enters the photochromic layer.

5. The display substrate according to claim 3, wherein the color-changing layer comprises cobalt oxide.

6. The display substrate according to claim 1, wherein the second wavelength light is within an infrared light wave band, the first sub-pixel is a blue sub-pixel, and the light-emitting layer is made of a material that emits an infrared light wider excitation of a blue light.

7. The display substrate according to claim 6, wherein the material that emits the infrared light under excitation of the blue light comprises K2SiF6:Mn4+ and K2SnF6:Mn4+.

8. The display substrate according to claim 1, wherein a groove is arranged on the first sub-pixel, the color-changing layer and the light-emitting layer are located in the groove of the first sub-pixel, and the groove is located in a central region or an edge region of the first sub-pixel.

9. A display module, comprising:
the display substrate according to claim 1;
a light source arranged on a light-incident side of the display substrate; and
an optical sensor arranged on a light-exiting side of the display substrate, and configured to collect the second wavelength light emitted by the light-emitting layer of at least one of the plurality of pixel units and reflected by a finger, and identify fingerprint information based on the collected second wavelength light.

10. The display module according to claim 9, wherein the first sub-pixel comprises a first portion covered by the color-changing layer and the light-emitting layer, and a second portion not covered by the color-changing layer and the light-emitting layer; and
the first portion of the first sub-pixel is configured to identify the fingerprint information in the first state, and the second portion of the first sub-pixel is configured to display an image under illumination of the light source.

11. The display module according to claim 9, wherein each of the plurality of pixel units further comprises a second sub-pixel and a third sub-pixel that are configured to display an image, and the first sub-pixel, the second sub-pixel, and the third sub-pixel are configured to emit lights with different colors.

12. A method for driving the display module according to claim 9, comprising:
when a fingerprint identification instruction is received, controlling the color-changing layer in at least one of the plurality of pixel units to be in the first state, to enable the first wavelength light to pass through the color-changing layer; and
turning on the light source, collecting, by using, the optical sensor, the second wavelength light emitted by the light-emitting layer in the at least one pixel unit and reflected by the finger, and identifying the fingerprint information based on the collected second wavelength light.

13. The method according to claim 12, wherein the first sub-pixel comprises a first portion covered by the color-changing layer and the light-emitting layer, and a second portion not covered by the color-changing layer and the light-emitting layer; and the method comprises:
when the fingerprint identification instruction. is received, controlling the first portion of the first sub-pixel in the at least one pixel unit and the optical sensor to identify the fingerprint information, and controlling the second portion of the first sub-pixel in the at least one pixel unit to display the image,

14. The method according to claim 12, wherein the color-changing layer is configured to cause the first wavelength light to be incapable of passing through the color-changing layer in the second state, and the display module comprises a first pixel unit and a second pixel unit that are adjacent to each other; and
the controlling the color-changing layer in the at least one pixel unit to be in the first state to enable the first wavelength light to pass through the color-changing layer comprises:
controlling a color-changing layer in the first pixel unit to be in the first state and controlling a color-changing layer in the second pixel unit to be in the second state, so that the first wavelength light transmits through the color-changing layer in the first pixel unit and enters the light-emitting layer.

15. The method according to claim 14, wherein the controlling the color-changing layer in the first pixel unit to be in the first state and controlling the color-changing layer in the second pixel unit to be in the second state comprises:
controlling a color-changing layer in a pixel unit in an odd-numbered row in an odd-numbered column to be in the first state, and controlling color-changing layers in other pixel units to be in the second state; or
controlling a color-changing layer in a pixel unit in an odd-numbered row in an even-numbered column to be in the first state, and controlling color-changing layers in other pixel. units to be in the second state; or
controlling a color-changing layer in a pixel unit in an even-numbered row in an odd-numbered column to be in the first state, and controlling color-changing layers in other pixel units to be in the second state; or
controlling a color-changing layer in a pixel unit in an even-numbered row in an even-numbered column to be in the first state, and controlling color-changing layers in other pixel units to be in the second state.

16. The method according to claim 15, wherein the controlling the color-changing layer in the first pixel unit to be in. the first state and controlling the color-changing layer in the second pixel unit to be in the second state comprises:
in a first time period, controlling the color-changing layer in the pixel unit in the odd-numbered row in the odd-numbered column to be in the first state, and controlling the color-changing layers in other pixel units to be in the second state; and in a second time period, controlling the color-changing layer in the pixel unit in the odd-numbered row in the odd-numbered column to be in the second state, and controlling the color-changing layers in other pixel units to be in the first state; or
in a first time period, controlling the color-changing layer in the pixel unit in the odd-numbered row in the even-numbered column to be in the first state, and controlling the color-changing layers in other pixel units to be in the second state; and in a second time period, controlling the color-changing layer in the pixel unit in the odd-numbered row in the even-numbered column to be in the second state, and controlling the color-changing layers in other pixel units to be in the first state; or
in a first time period, controlling the color-changing layer in the pixel unit in the even-numbered row in the odd-numbered column to be in the first state, and controlling the color-changing layers in other pixel units to be in the second state; and in a second time period, controlling the color-changing layer in the pixel unit in the even-numbered row in the odd-numbered column to be in the second state, and controlling the color-changing layers in other pixel units to be in the first state; or
in a first time period, controlling the color-changing layer in the pixel unit in the even-numbered row in the even-numbered column to be in the first state, and controlling the color-changing layers in other pixel units to be in the second state; and in a second time period, controlling the color-changing layer in the pixel unit in the even-numbered row in the even-numbered column to be in the second state, and controlling the color-changing layers in other pixel units to be in the first state,

17. A display apparatus, comprising the display module according to claim 9.
